(19) United States
(12) Patent Application Publication
(10) Pub. No.: US 2004/0123812 A1
(43) Pub. Date: Jul. 1, 2004

(54) Semi-automatic animal litter

(76) Inventor: John C. Condon, Thousand Oaks, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/698,860

(22) Filed: Oct. 31, 2003

Related U.S. Application Data
(60) Provisional application No. 60/423,243, filed on Nov. 1, 2002.

(51) Int. Cl. A01K 23/00

(52) U.S. Cl. 119/867

(57) ABSTRACT

An animal litter apparatus for gathering pet waste includes an outer tube including an open end. A closed end of a disposable bag is held within the outer tube. The apparatus moves between open and closed configurations. A clamp assembly grasps the waste as the apparatus moves from the open configuration to the closed configuration. The clamp assembly is connected generally about a perimeter of the outer tube open end. The clamp assembly brings the waste into the bag as the apparatus moves from the open configuration to the closed configuration.

### RELATED APPLICATION

Priority is claimed to filing date of U.S. Provisional Patent Application Serial No. 60/423,243, filed Nov. 1, 2002.

### BACKGROUND OF THE INVENTION

The present invention generally relates to an apparatus for retrieving pet waste and more particularly to a reusable device for gathering pet waste into a disposable bag.

Pet ownership comes with many responsibilities. These responsibilities include feeding, sheltering and tending to a pet's basic needs. One particular basic is the pet's need to rid itself of bodily waste on a regular basis via urination and/or defecation. In the case of a dog, the dog's owner may take his/her dog for a walk along a street or to a park where the animal may urinate and/or defecate on the street, sidewalk, gutter, etc. However, in many cities, towns and villages, local health and safety ordinances (commonly known as ‘pooper-scooper’ laws') require a pet owner to remove and dispose of the fecal waste left on the ground, or wherever their pet has defecated, in a public place. Many of these ordinances provide that failure to properly dispose of a pet's waste can result in a pet owner receiving a citation for a violation of the ordinance. If convicted of the violation, the pet owner may find him/herself fined a substantial monetary sum.

The need to pick up a pet's fecal waste is not limited only to public places. A pet owner may also wish to keep a privately-owned area, such as the backyard of their home, free of animal waste. Typically, pet owners who have a backyard where their pet defecates do not wish to see their pet's waste accumulate over time. A pet owner may wish to use their backyard for a purpose other than as a pet waste depository and may also wish to reduce the risk of stepping on waste left behind by their pet. Therefore, for cleanliness reasons, a pet owner may wish to dispose of fecal waste left behind by their pet in their backyard.

The most simple device used to pick up pet waste is a simple plastic bag. After a pet has defecated, the pet owner places one of his/her hands into the plastic bag like the bag was a fingerless glove. The pet owner then places the bottom of the plastic bag on top of the fecal waste. Then, through the plastic bag, the pet owner grabs and lifts the fecal waste off the ground; wrapping the sides of the bag around the fecal waste by turning the bag inside out so that the fecal waste is now contained within the inside-out plastic bag. The plastic bag can then be disposed of in a trash container or other similar container designated for waste disposal.

However, many pet owners do not wish to be in such close contact with their pet's waste. The thought of grabbing fecal waste by hand, even through a plastic bag, is revolting to many individuals. Even pet owners who are not daunted by the prospect of grabbing their pet's fecal waste in the manner described above, are revolted by the risk that one of these plastic bags may contain an undiscovered hole through which fecal matter could pass and come in contact with the pet owner's hand.

A number of devices have been created for the purpose of removing pet fecal waste in a manner that limits contact with that waste. However, many of these devices, for example, U.S. Pat. No. 5,370,431, still require that a user's hand come in close contact with a disposable bag filled with pet fecal matter. Other devices, for example, U.S. Pat. No. 6,086,123, do nothing to hide the retrieved pet fecal waste from the sight of other members of the public who may be disgusted and/or nauseated by the sight and/or smell of pet fecal waste.

Accordingly, there is a need for an apparatus for retrieving pet waste which allows a user to retrieve pet fecal waste without requiring the user to come in close contact with a disposable bag filled with pet fecal waste. There is an additional need for an apparatus that is inexpensive and easy to manufacture. There is an additional need for an apparatus to gather pet waste while preserving the cleanliness of the user's hands and clothing. The present invention satisfies these needs and provides other related advantages.

### SUMMARY OF THE INVENTION

The apparatus is designed to assist a pet owner who enjoys walking their pet animal(s) in public places such as the neighborhood surrounding their dwelling, local park, beach or city where it is common courtesy and/or state law to clean up fecal waste left by the pet(s). The apparatus is also helpful to the pet owner for daily cleanup at home.

This apparatus allows any pet owner to dispose of his/her pet waste without having to touch or pick the waste up by placing a hand through a plastic bag and removing it by grabbing the waste and pulling the bag inside out. This apparatus also allows the user to carry the waste inside a closed bag and concealed inside the device until the user gets to the closest trash can where the bag may be disposed of.

An animal litter apparatus for gathering pet waste includes an outer tube including an open end. The apparatus also includes a means for holding a closed end of a disposable bag within the outer tube and a means for moving the apparatus between open and closed configurations.

A clamp assembly on the apparatus grasps the waste as the apparatus moves from the open configuration to the closed configuration and is connected to the outer tube generally about a perimeter of the open end of the outer tube. The clamp assembly brings the waste into the bag as the apparatus moves from the open configuration to the closed configuration.

The apparatus further includes an inner tube slidably movable within the outer tube, and positioned within and coaxial with the outer tube along a longitudinal axis.

The holding means is connected to the inner tube.

The apparatus additionally includes a spring connecting the inner tube to the moving means. The inner tube moves away from the open end of the outer tube, pulling the bag further within the outer tube as the apparatus moves from the open configuration to the closed configuration.

The apparatus also includes a gear assembly operationally connecting the inner tube and the outer tube.

The outer tube is rotatable about the longitudinal axis, and the clamp assembly is connected to the outer tube to rotate with the outer tube, twisting an open end of the bag closed.

The clamp assembly includes at least two jaws, pivotally movable towards the open end of the outer tube as the apparatus moves from the open configuration to the closed configuration. The outer tube surrounds a portion of the jaws as the apparatus moves from the open configuration to the closed configuration.

The holding means includes a clamp. The clamp includes two grips for holding the bag therebetween.

The outer tube is operationally connected to the clamp assembly whereby slidable movement of the outer tube along a longitudinal axis away from and towards the clamp assembly respectively opens and closes the clamp assembly.

The moving means includes a trigger assembly operationally connected to the holding means. The moving means further includes a handle portion operationally connected to the outer tube. The handle portion includes at least two spur gears, the outer tube includes a plurality of grooves, and the inner tube includes a first gear drive and a second gear drive. The spur gears pivot between the grooves of the outer tube and the gear drives of the inner tube such that the handle portion operationally connects the inner tube and the outer tube.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is an orthogonal view of a closed animal litter embodying the invention;

FIG. 2 is a side view of the animal litter of FIG. 1;

FIG. 3 is a cross-sectional side view of the animal litter of FIG. 1 taken along line 3-3 of FIG. 2;

FIG. 4 is a top plan view of the animal litter of FIG. 1;

FIG. 5 is a bottom plan view of the animal litter of FIG. 1;

FIG. 6 is an orthogonal view of a partially-open animal litter embodying the invention;

FIG. 7 is a top plan view of the animal litter of FIG. 6;

FIG. 8 is a side view of the animal litter of FIG. 6;

FIG. 9 is a cross-sectional side view of the animal litter of FIG. 6 taken along line 9-9 of FIG. 8;

FIG. 10 is a bottom plan view of the animal litter of FIG. 6 taken along line 10-10 of FIG. 8;

FIG. 11 is a side view of a fully-open animal litter of FIG. 1;

FIG. 12 is a cross-sectional side view of the animal litter of FIG. 11 taken along line 12-12 of FIG. 11;

FIG. 13 is a bottom plan view of the animal litter of FIG. 11 taken along line 13-13 of FIG. 11;

FIG. 14 is a fragmented top plan view of the inside tube with closed clamps;

FIG. 15 is a fragmented bottom plan view of the inside tube with closed clamps;

FIG. 16 is a fragmented top plan view of the inside tube with fully open clamps;

FIG. 17 is a fragmented bottom plan view of the inside tube with fully open clamps;

FIG. 18 is a fragmented front view of the clamps showing an alternative cable;

FIG. 19 is an orthogonal view of another embodiment of an animal litter embodying the invention;

FIG. 20 is a cross-sectional view of the animal litter of FIG. 19 taken along line 20-20 of FIG. 19;

FIG. 21 is a cross-sectional side view of yet another embodiment of an animal litter embodying the invention;

FIG. 22 is an orthogonal view of an additional embodiment of an closed animal litter embodying the invention;

FIG. 23 is a front elevational view of the animal litter of FIG. 22;

FIG. 24 is a back elevational view of the animal litter of FIG. 22;

FIG. 25 is a side elevational view of the animal litter of FIG. 22;

FIG. 26 is another side elevational view of the animal litter of FIG. 22;

FIG. 27 is a top plan view of the animal litter of FIG. 22;

FIG. 28 is a bottom plan view of the animal litter of FIG. 22;

FIG. 29 is a cross-sectional side elevational view of the animal litter of FIG. 22 taken along line 29-29; and

FIG. 30 is a cross-sectional top plan view of the animal litter of FIG. 22 taken along line 30-30.

### DETAILED DESCRIPTION OF THE PREFERRED EMBODIMENTS

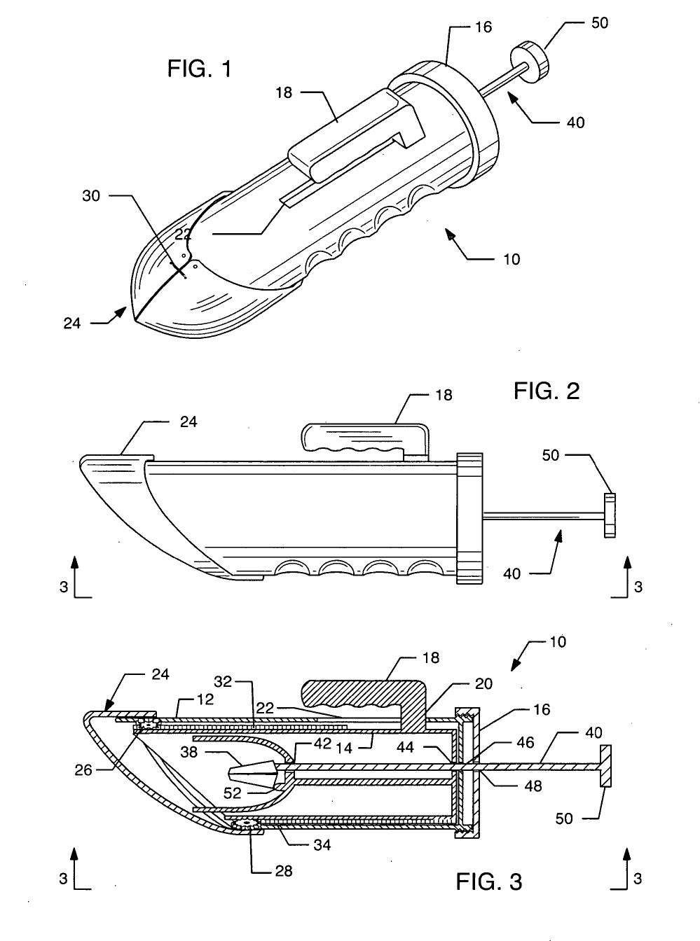

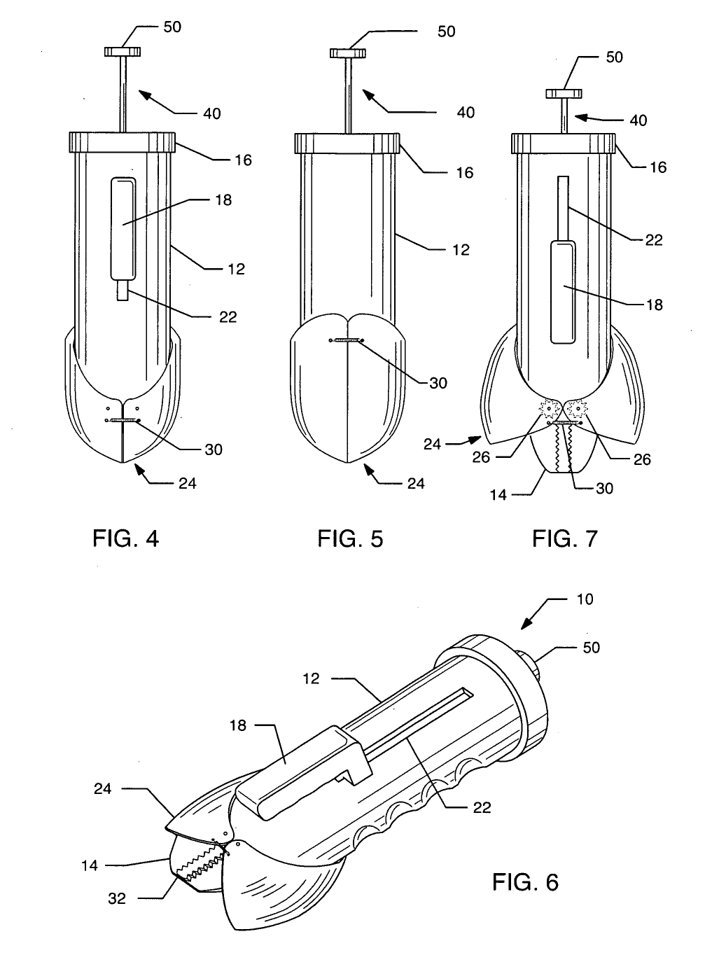

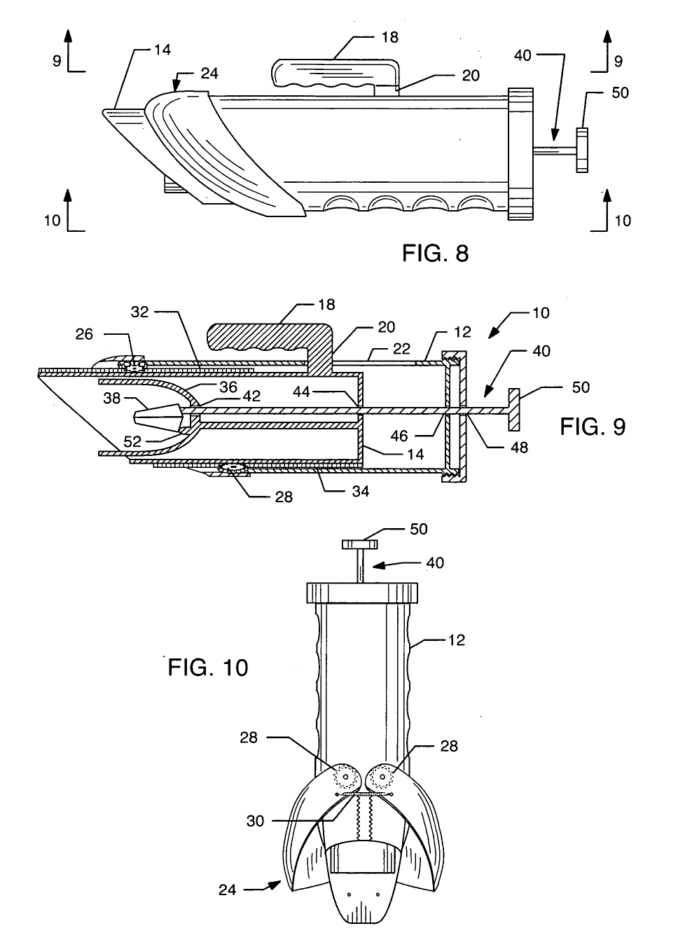

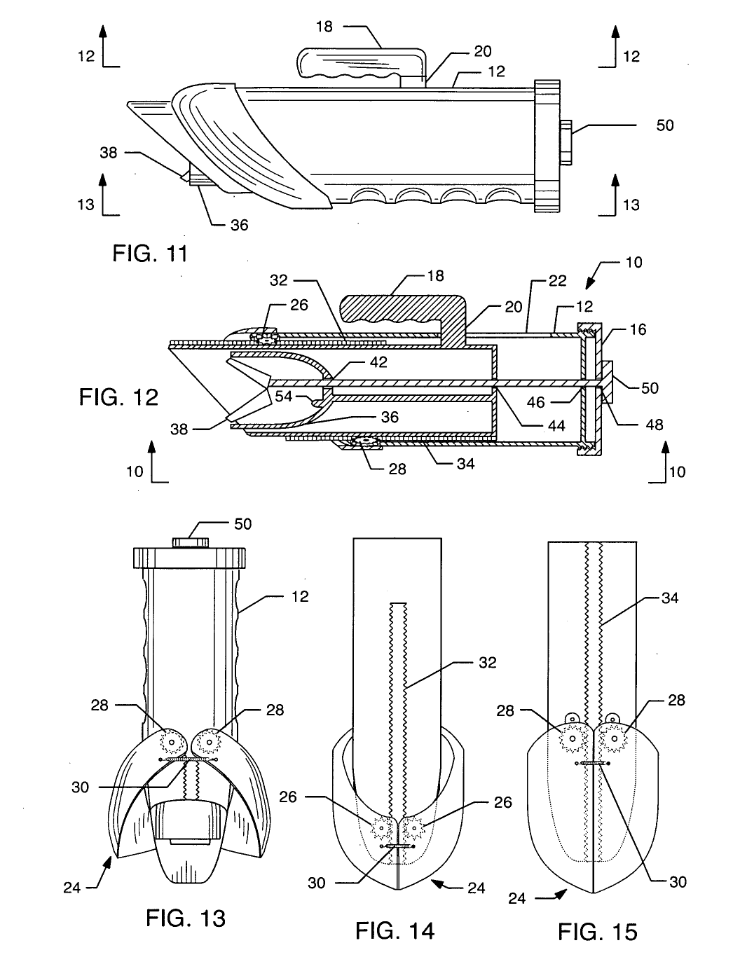

As illustrated in the accompanying FIGS. 1-17, the present invention resides in a reusable animal litter apparatus 10 for gathering pet waste into a disposable bag. FIGS. 1-17 illustrate the same apparatus 10 in closed, partially-open, and fully open positions. FIGS. 1-5, 14 and 15 illustrate the apparatus 10 in a closed position. FIGS. 6-10 illustrate the apparatus 10 in a partially-open position while FIGS. 11-13, 16 and 17 illustrate the apparatus 10 when it is fully open.

The apparatus 10 includes an outer tube 12 and an inner tube 14 fitted one inside the other with a cap 16 affixed to a closed end of the outer tube 12. The cap 16 may be screwed on to the outer tube 12. A handle 18 for moving the inner tube 14 along the length of the interior of the outer tube 12 is attached to the inner tube 14. A protrusion 20 of the inner tube 14 extends through a slot longitudinal 22 in the outer tube 12 to where the protrusion 20 attaches to the handle 18. Front ends of the inner tube 14 and the outer tube 12 are angled at approximately 30 degrees to 60 degrees. A main grip or clamp 24 in the form of a set of opening and closing clamp-like jaws, is mounted to the open front end of the outer tube 12 opposite the end of the outer tube 12 closest to a user. The spring-loaded jaws of the main clamp 24 open and close as the inner tube 14 is moved back and forth within the outer tube 12. As the handle 18 of the inner tube 14 is moved towards the distal end of the outer tube 12, the jaws of the main clamp 24 open. As the handle 18 is pulled back towards the user, the jaws of the main clamp 24 close.

The jaws of main clamp 24 are pivotally attached to the outer tube 12 at upper and lower locations on the exterior of the outer tube 12. Each jaw of the main clamp 24 is also pivotally attached to an upper cam or gear 26 and a lower cam or gear 28 where each gear 26, 28 is located on the interior of the outer tube 12. A number of springs 30 connect the jaws of the main clamp 24 such that the springs 30 pull the jaws of the main clamp 24 into a closed position. The ends of the springs 30 are located on the jaws of the main clamp 24 between the ends of the jaws and the upper and lower gears 26, 28.

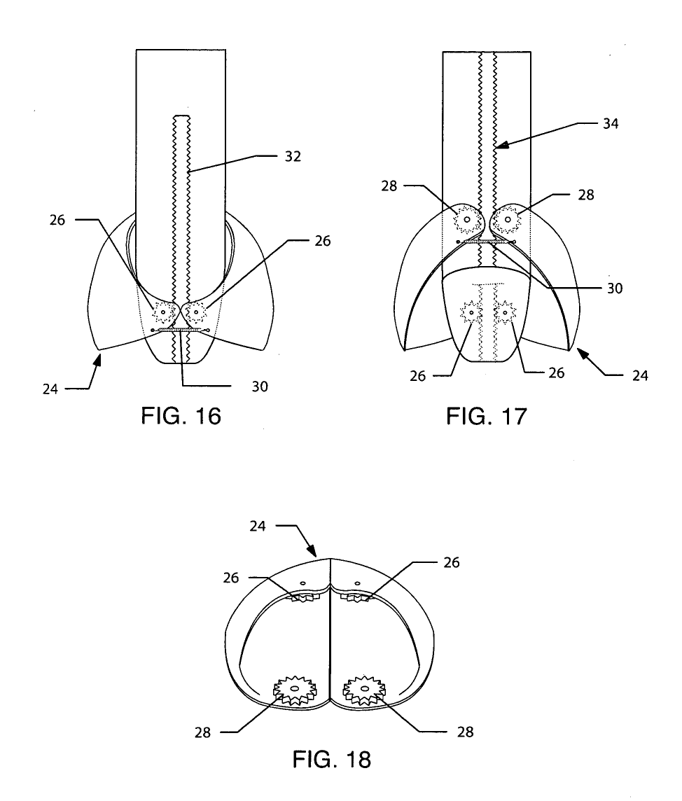

The inner tube 14 further includes an upper gear drive strip 32 and a lower gear drive strip 34. The upper gears 26 mate with the upper gear drive strip 32 and the lower gears 28 mate with the lower gear drive strip 34. Each gear drive strip 32, 34 includes a plurality of ridges along their length that match mating ridges on each gear 26, 28. The ridges may be sawtooth-shaped. The movement of the gears along the drive strips 32, 34 opens and closes the jaws of the main clamp 24. FIGS. 14 and 15 illustrate the positions of the upper gears 26, lower gears 28 on upper gear drive strip 32 and lower gear drive strip 34, respectively, when the main 24 clamp is closed. FIGS. 16 and 17 illustrate the positions of the upper gears 26, lower gears 28 on upper gear drive strip 32 and lower gear drive strip 34, respectively, when the main clamp 24 is open. The springs 30 act to pull the jaws of the main clamp 24 closed.

A holder 36 attached to the inner tube 14 is configured within the inner portion of the inner tube 14. A bag clamp 38 with a pair of spring-loaded jaws is positioned within the holder 36. The bag clamp 38 is attached to a bag clamp slide 40 which runs through a series of slots 42, 44, 46, 48 located in the holder 36, inner tube 14, outer tube 12 and cap 16. The slots 42, 44, 46, 48 align the bag clamp slide 40 for use. A grip 50 is located on the portion of the bag clamp slide 40 outside the cap 16. The grip 50 allows the user to adjust the position of the bag clamp 38 within the apparatus 10 and prevents the slide 40 from slipping out through the slots 42, 44, 46, 48. The holder 36 further includes a protrusion 52 upon which the bag clamp 38 rests. When a user pulls the bag clamp slide 40 back against the protrusion 52, pressure from the protrusion 52 closes the jaws of the bag clamp 38.

FIGS. 1-5 illustrate the apparatus 10 in the closed position with the handle 18 positioned all the way back and the bag clamp slide 40 positioned all the way back, ready for use. This is the same position the device will be in after it is used and time to release the disposable bag and contents into a trash can. The bag clamp slide 40 does not need to be all the way back and vulnerable to damage unless the apparatus 10 has just been used and is ready to be emptied.

Before the apparatus 10 can be used, the user must first prepare the apparatus 10 by positioning a disposable plastic bag onto and within the apparatus 10. This preparation may be done before, during, or after the user's pet has defecated. FIGS. 11 and 12 illustrate the apparatus 10 in an open position with the handle 18 positioned all the way forward and ready for bag loading. The user opens the bag clamp 38 and places the closed end of the disposable bag into the inner tube 14 and into the bag clamp 38 and then closes the bag clamp 38 by pulling back on the bag clamp slide 40 until back of the bag clamp 38 contacts firmly against protrusion 52 on holder 36. As illustrated in FIGS. 3 and 9, the protrusion 52 exerts pressure on the jaws of the bag clamp 38. As the bag clamp slide 40 is pulled further back by the user, the pressure exerted by the protrusion 52 on the bag clamp 38 closes the jaws of the bag clamp 38. The user then wraps the open end of the disposable bag over the outside and around the perimeter of the main clamp 24 which is already in the open position. The disposable bag is now ready for use.

As illustrated in FIGS. 6-13, the ability to extend the inner tube 14 past the outside main clamp 24 allows the disposable bag to be forced completely around the pet fecal waste as the clamp slide 40 is pushed forward and the bag positioned over the fecal waste. The open end of the apparatus 10 is placed completely and firmly over the pet waste such that the front angled ends of the tubes 12, 14 are approximately parallel to the ground. If is desirable for the user to position the apparatus 10 around the fecal waste such that the perimeter of the inner tube 14 will surround at least a majority of the fecal waste. Naturally, the size, shape and solidity of the fecal matter may vary from pet-to-pet, bowel movement-to-bowel movement. The user then pushes the handle 18 towards the main clamp 24 such that, with the jaws of the main clamp 24 open, the perimeter edge of the front end of the inner tube 14 comes in close contact with the ground or other surface upon which the fecal waste rests. The user then pulls back on the handle 18 of the inner tube 14, retracting the inner tube 14 within the outer tube 12, causing the bag-covered jaws of the main clamp 24 to close and come between the ground and the waste. The movement of the jaws of the main clamp 24 lifts the waste and brings the majority of the waste-filled disposable bag, still clamped to the bag clamp 38 of the inside tube 14, into the apparatus 10. A portion of the edges of the open end of the now waste-filled bag extend slightly past the closed jaws of the main clamp 24.

In order to twist-close the open end of the bag, the user pulls bag clamp slide 40 as far back as the clamp slide 40 will go while concurrently twisting the clamp slide 40 several times, clockwise or counter-clockwise. This allows the fecal waste to remain out of sight and to contain the foul odor associated with the fecal waste even after the waste is released into a trash can. The user then positions the front end of the apparatus 10, containing the now closed bag, over an open trash can. The user then opens jaws of the main clamp 24 and the bag clamp 38 so that the disposable bag may be released into the trash can. FIG. 1 illustrates the apparatus 10 in the closed position with the handle 18 all the way back and the inside bag clamp-side 40 all the way back as if the apparatus 10 was just used and the user ready to release the waste-filled bag into the trash can.

FIG. 18 illustrates an alternate embodiment of the present invention with the jaws of the main clamp 24 in a closed position. Two solid-ridged plastic cables 54 may be attached to the gears 26, 28. Each cable 54 is attached to one of the upper gears and to one of the lower gears 28 at the bottom on opposite sides. This arrangement allows the cables 54 to sweep along the inside of the main clamp 24 and force a disposable bag located in the path of the sweeping cables 54 into a central position within the inner tube 14.

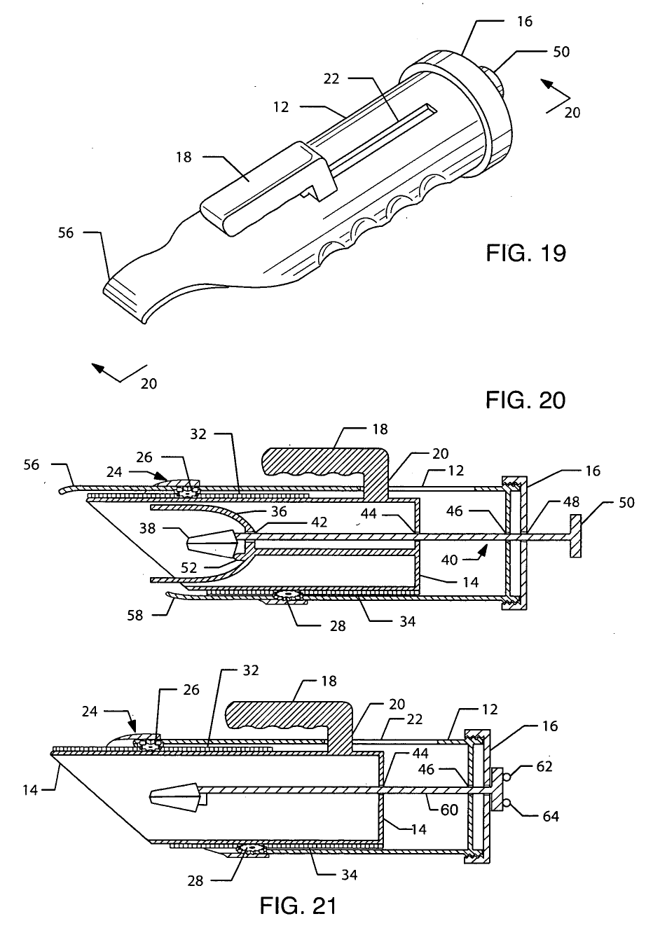

FIGS. 19 and 20 illustrate an alternative embodiment of the present invention where the outer tube 12 of the apparatus 10 has been modified. The jaws of the main clamp 24 are not shown in FIG. 19 for reasons of clarity. The front portion of the outer tube 12 has been extended on the top and bottom portions of the outer tube 12 such that the respective top and bottom extensions 56, 58 curvingly protrude from the front end of the outer tube 12

FIG. 21 illustrates another alternative embodiment of the present invention where a modified bag clamp 60 is used within the apparatus 10. The bag clamp 60 is attached to the inner tube 14. In use, two buttons 62, 64 are located on the end of the apparatus 10 closest to the user. These two buttons include a top button 62 which, when pressed, opens the bag clamp 60 which is located inside the opposite end of the inside tube 14 and a bottom button 64, which, when pressed, closes the bag clamp 60. The buttons 62, 64 that open and close the bag clamp 60 are connected to a conventional mechanism able to open and close the jaws of the bag clamp 60 where such a conventional mechanism is well-known to those of ordinary skill in the art.

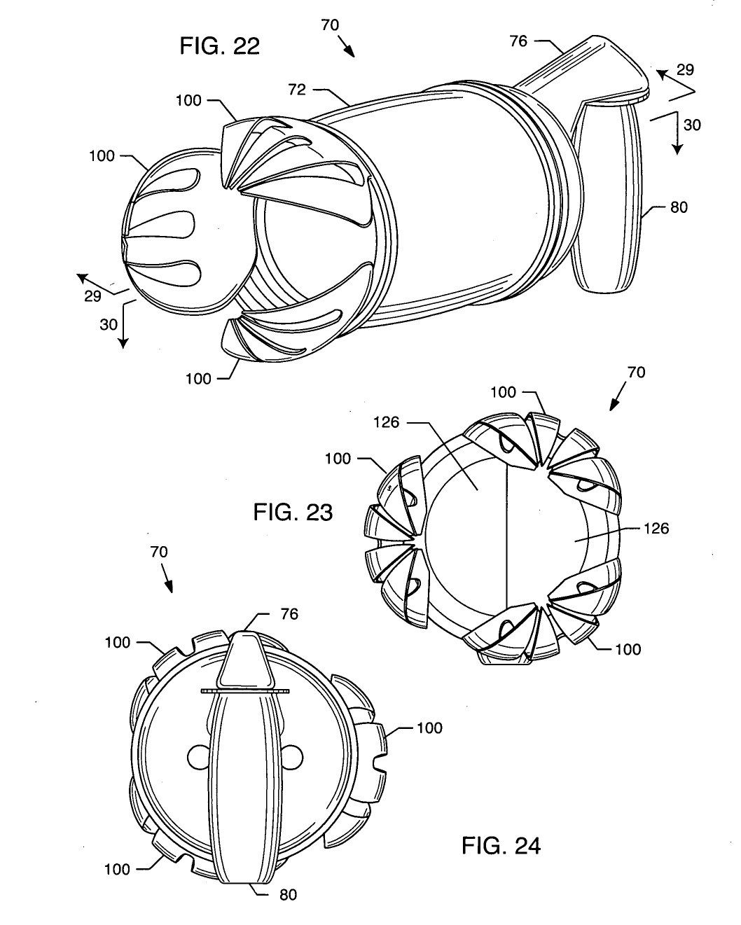

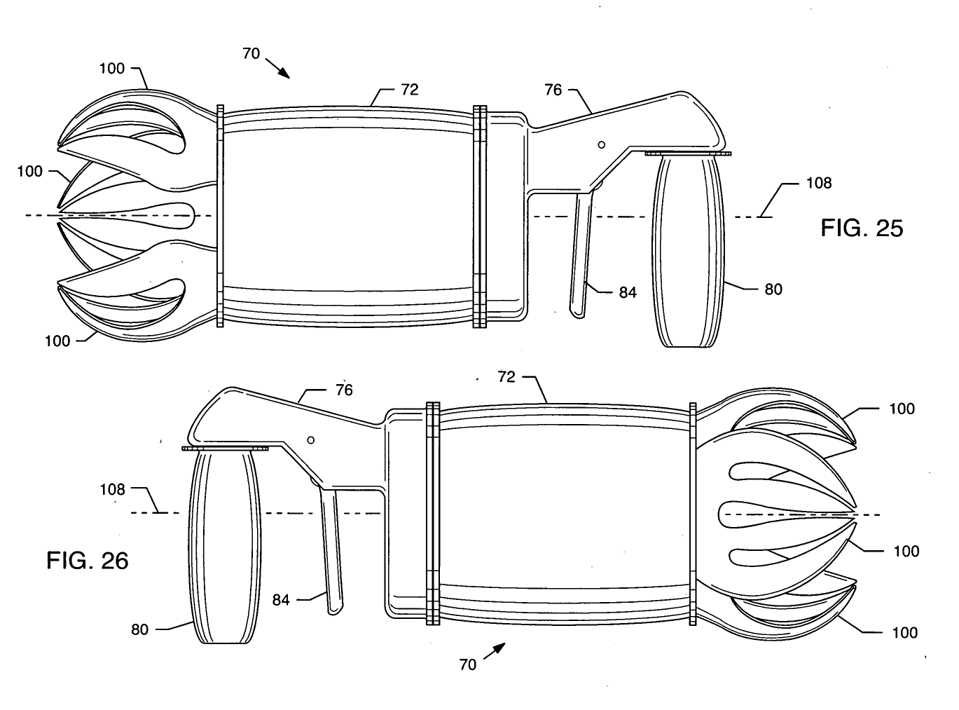

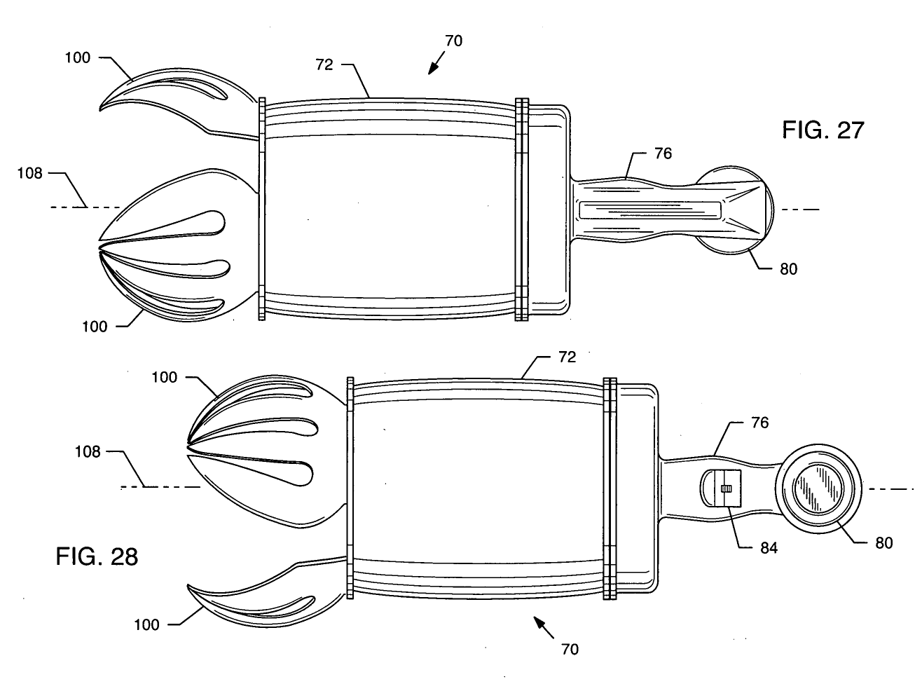

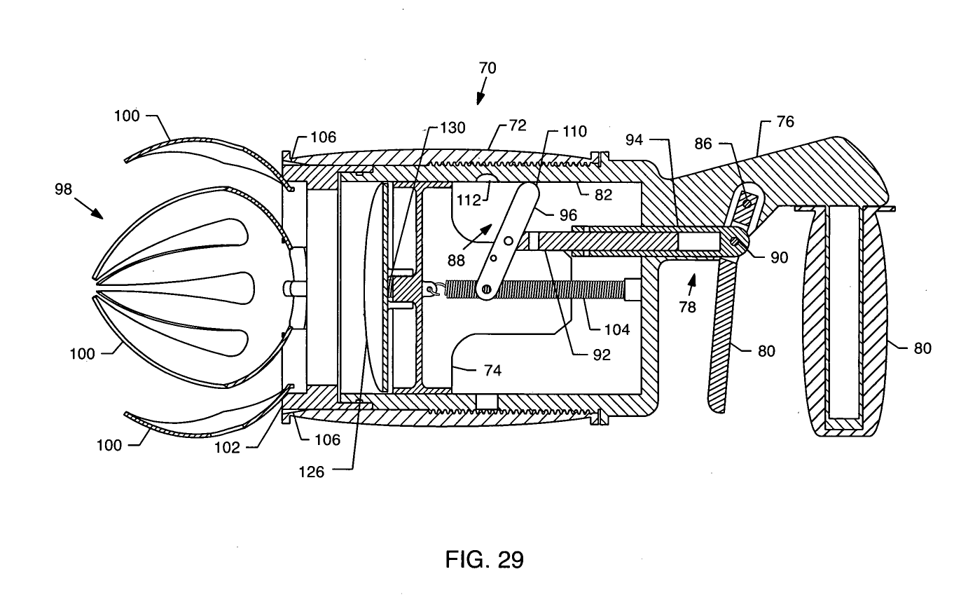

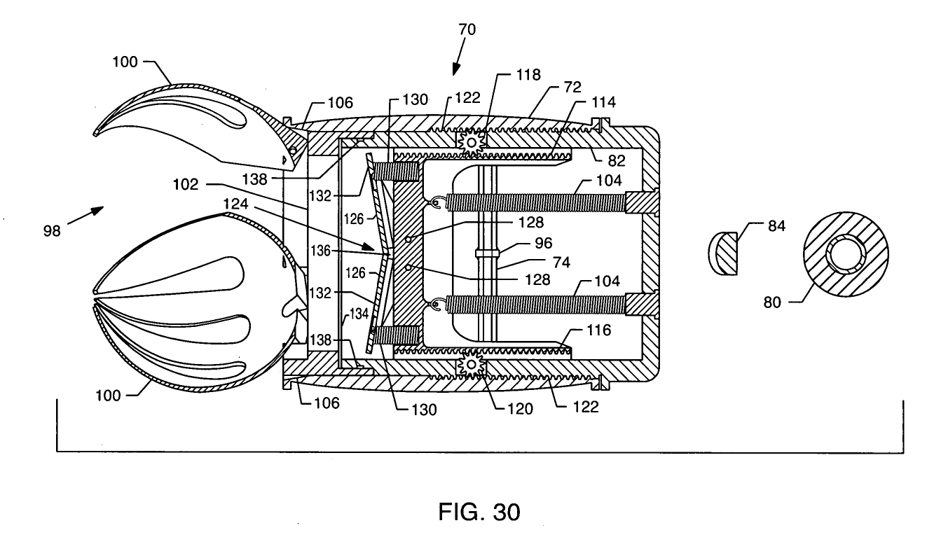

FIGS. 22-30 illustrate an additional embodiment of the present invention. The apparatus 70 includes a sleeve or outer tube 72 and a piston or inner tube 74 fitted one inside the other. A handle 76 for moving the inner tube 74 and the outer tube 72 relative to each other is connected by a mechanism 78 to the outer tube 72 and the inner tube 74.

The handle 76 includes a grip 80 around which a user wraps the fingers of at least one of their hands and a tubular sleeve portion 82 generally located between the outer tube 72 and the inner tube 74. The sleeve portion 82 is open on one end and closed on the end closest to the grip 80. The mechanism 78 includes a trigger 84 connected to the handle 76 at a pivot 86 and connected to a mechanical linkage 88 at a pivot 90. The mechanical linkage 88 includes a rod 92 which runs through a bore 94 in the handle 76 to the interior of the outer tube 72 where the rod 92 is connected via a link 96 to the inner tube 72. The link 96 is pivotally connected at one point along its length to the rod 92 and pivotally connected to the inner tube 74 at another point along its length.

A main grip or clamp assembly 98 includes a number of opening and closing clamp-like jaws 100 (for the purpose of illustration, three clamp-like jaws 100 are shown) mounted to an annular collar 102 connected to the sleeve portion generally near the open front end of the outer tube 72 opposite the end of the outer tube 72 closest to a user. These pivotally opening/closing jaws 100 of the clamp assembly 98 are pivotally spring-loaded such that the jaws 100 open and close as the inner tube 74 is moved back and forth within the outer tube 72. The jaws 100 have a continuous surface or include a number of flexible tines (as shown). One or more springs 104 (two springs 104 are shown for the purpose of illustration) connect the inner tube 74 to the outer tube 72. The springs 104 are connected to the closed end of the sleeve portion 82 of the handle 76. The outer and inner tubes 72, 74 move relative to each other such that, as the inner tube 74 moves towards the user, the outer tube 72 moves away from the user. A portion 106 of the interior perimeter surface of the outer tube 72 at the front open end of the outer tube 72 is angled, approximately ten degrees, such that as the outer tube 72 moves away from the user, this portion 106 of the outer tube 72 abuts against the exterior of the jaws 100, partially encircling the jaws 100 as the outer tube 72 passes over the jaws 100, pushing the jaws 100 towards a central longitudinal axis 108 of the outer tube 72 and closing the jaws 100 towards their position in the closed configuration of the apparatus 70. As the jaws 100 are pivotally spring-loaded, the jaws 100 automatically move towards their position in the open configuration of the apparatus 70 when the outer tube 72 moves back towards the user and off the jaws 100. The inner tube 74 is coaxial with the outer tube 72 and shares the longitudinal axis 108 with the outer tube 72.

As the user pulls the trigger 84, the trigger 84 pulls the rod 92 towards the user. This causes the rod 92 to pull on the link 96; causing the link 96 to pivot towards the user. When the apparatus 70 is in the open configuration, one end 110 of the link 96 rests within a recess 112 in the sleeve portion 82. Pulling the trigger 86 has the effect of pulling the end 110 of the link 96 ut of the recess 112, releasing the inner tube from a locked position in the open configuration so that the spring(s) 104 pull the inner tube 72 towards the user. As the inner tube 72 moves towards the user, the jaws 100 of the clamp assembly 98 close towards their position in the closed configuration. As the inner tube 72 moves away from the user, the jaws 100 of the clamp assembly 98 move towards their position in the open configuration.

The inner tube 74 further includes a left gear drive strip 114 and a right gear drive strip 116. A left spur gear 118 and a right spur gear 120 are connected to opposite sides of the sleeve portion 82 such that the gears 118, 120 are able to turn about a pivot. The left gear 118 mates with the left gear drive strip 114 and the right gear 120 mate with the right gear drive strip 116. Each gear drive strip 114, 116 includes a plurality of ridges along their length that match mating ridges on each gear 118, 120. The ridges may be sawtooth-shaped. The gears 118, 120 engage the drive strips 114, 116 and the movement of the gears 118, 120 along the drive strips 114, 116 move the outer and inner tubes 72 74 back and forth relative to each other, in addition to resulting in the opening and closing of the jaws 100 of the clamp assembly 98 as movement of the inner tube 74 causes movement of the outer tube 72 which in turn causes movement of the jaws 100 of the clamp assembly 98. The outer tube 72 includes a plurality of grooves 122 along a portion of the perimeter of the interior surface of the outer tube 72. The gears 118, 120 engage the grooves 122 in the same or similar manner as the gears 118, 120 engage the drive strips 114, 116.

A bag clamp 124 with a pair of spring-loaded jaws or grips 126 is connected to the surface of the inner tube 74 facing the open end of the outer tube 72. Each grip 126 is connected at a pivot 128 to the inner tube 74. Each grip 126 is also connected by a compressive spring 130 to the inner tube 74. As the inner tube 74 is moved towards the open configuration and locked into position, a surface 132 of each grip 126 abuts against a shoulder 134 of the collar 102. As the grip 126 contacts the shoulder 134, the shoulder 134 pushes against each grip 126, causing each grip 126 to turn about its respective pivot 128 and compress the springs 130. As the surfaces 132 become generally adjacent to and parallel with the shoulder 134, a space 136 opens up between the grips 126. It is within this space 136 that a portion of the closed end of a disposable bag (not shown) is inserted. An open end of the bag extends out from the interior of the outer tube 72 beyond and/or may be partially wrapped around the jaws 100. When the trigger 84 is pulled, releasing the inner tube 74 to move back towards its position in the closed configuration, the grips 126 move away from the shoulder 134, causing the springs 130 to expand and push against the grips 126 and pivot the grips 126 such that ends of each grip 126 move towards each other, closing the space 136 between the grips 126, resulting in the disposable bag being held tightly between the grips 126.

The outer tube 72 is rotatable freely about the longitudinal axis 108. The grooves 122 allow the outer tube 72 to rotate without interference from the gears 114, 116 as the teeth of the gears 114, 116 pass along the grooves 122. The clamp assembly 98 connectively engages the sleeve portion 82 along a groove 138 around the perimeter of the sleeve portion 82 such that the clamp assembly 98 is able to freely rotate about the sleeve portion 82. The clamp assembly 98 engages the outer tube 72 such that the clamp assembly 98 rotates with the outer tube 72 as the outer tube 72 rotates, twisting the open end of a bag held by the grips 126 closed when the apparatus 70 is in the closed configuration. The clamp assembly 98 and the outer tube 72 are connected to each other by a pin and groove combination (not shown). Alternatively, the pressure of the friction-fit of the spring-loaded jaws 100 against the interior surface of the outer tube 72 when the apparatus 70 is in the closed configuration may be sufficient in itself to make the clamp assembly 98 rotate as the outer tube 72 rotates.

Before the apparatus 70 can be used, the user must first prepare the apparatus 70 by positioning a disposable plastic bag (not shown) onto and within the apparatus 70. This preparation may be done before, during, or after the user's pet has defecated. If the apparatus 70 is in the closed configuration, the user moves the apparatus 70 to the open configuration by holding the grip 80 with one hand and holding the outer tube 72 with the other hand. The user pulls the outer tube 72 towards their body, causing opens the inner tube 74 to move forward until the end 110 of the link 96 is caught within the recess 112, locking the apparatus in the open configuration. As outlined above, the grips 126 are opened so that the closed end of a bag can be placed within the space 136 between the grips 126. The user then places the closed end of the disposable bag between the grips 126 and places the perimeter of the open end of the bag over the outside of and around the perimeter of the jaws 100 of the clamp assembly 98 which is already in the open position. The disposable bag is now ready for use.

The open end of the clamp assembly 98 is placed completely and firmly over the pet waste such that the front angled ends of the jaws 100 are approximately parallel to the ground. It is desirable for the user to position the apparatus 70 around the fecal waste such that the perimeter of the jaws 100 will surround at least a majority of the fecal waste. Naturally, the size, shape and solidity of the fecal matter may vary from pet-to-pet, bowel movement-to-bowel movement. The user then pulls the trigger 84, releasing the end 110 of the link 96 from the recess 112 such that the springs 104 pull the inner tube 74 towards the user, causing the gears 118, 120 to turn such that the outer tube 72 moves away from the user, causing the bag-covered jaws 100 of the clamp assembly 98 to close and come between the ground and the waste. The movement of the jaws 100 of the clamp assembly 99 lifts the waste and brings the majority of the waste-filled disposable bag, into the apparatus 70. As the inner tube 72 moves towards the user, the grips 126 clamp the bag in place in the space 136. A portion of the edges of the open end of the now waste-filled bag extend slightly past the closed jaws 100 of the clamp assembly 98.

The grips 126 hold the closed end of the bag stationary. In order to twist-close the open end of the bag, the user rotationally twists the outer tube 72 several times, clockwise or counter-clockwise. As the clamp assembly 98 rotates, the open end of the bag is twisted closed. Drawing the bag into the apparatus 70 allows the fecal waste to remain out of sight and twisting the bag closed contains the foul odor associated with the fecal waste even after the waste is released into a trash can. The user then positions the front end of the clamp assembly 98 of the apparatus 70, containing the now closed bag, over an open trash can and opens the jaws 100 by moving the apparatus 70 to the open configuration so that the disposable bag may be released into the trash can. In the alternative, if a user desire to keep the fecal waste for testing by a veterinarian, the user may move the apparatus 70 to the open configuration while holding the twisted closed opening of the bag extending past the jaws 100 so that the user can hold the bag once the bag has been released from the apparatus 70.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

What is claimed is:

1. An animal litter apparatus for gathering pet waste, comprising:
an outer tube including an open end;
means for holding a closed end of a disposable bag within the outer tube;
means for moving the apparatus between open and closed configurations; and
a clamp assembly for grasping the waste as the apparatus moves from the open configuration to the closed configuration, connected generally about a perimeter of the outer tube open end;
wherein the clamp assembly brings the waste into the bag as the apparatus moves from the open configuration to the closed configuration.

2. The apparatus of claim 1, including an inner tube slidably movable within the outer tube, and positioned within and coaxial with the outer tube along a longitudinal axis.

3. The apparatus of claim 2, wherein the holding means is connected to the inner tube.

4. The apparatus of claim 2, including a spring connecting the inner tube to the moving means.

5. The apparatus of claim 2, wherein the inner tube moves away from the open end of the outer tube, pulling the bag further within the outer tube as the apparatus moves from the open configuration to the closed configuration.

6. The apparatus of claim 2, including a gear assembly operationally connecting the inner tube and the outer tube.

7. The apparatus litter of claim 1, wherein the outer tube is rotatable about a longitudinal axis, and the clamp assembly is connected to the outer tube to rotate with the outer tube, twisting an open end of the bag closed.

8. The apparatus of claim 1, wherein the clamp assembly includes at least two jaws, pivotally movable towards the open end of the outer tube as the apparatus moves from the open configuration to the closed configuration.

9. The apparatus of claim 8, wherein the outer tube surrounds a portion of the jaws as the apparatus moves from the open configuration to the closed configuration.

10. The apparatus of claim 1, wherein the holding means includes a clamp.

11. The apparatus of claim 10, wherein the clamp includes two grips for holding the bag therebetween.

12. The apparatus of claim 1, wherein the outer tube is operationally connected to the clamp assembly whereby slidable movement of the outer tube along a longitudinal axis away from and towards the clamp assembly respectively opens and closes the clamp assembly.

13. The apparatus of claim 1, wherein the moving means includes a trigger assembly operationally connected to the holding means.

14. The apparatus of claim 13, wherein the moving means includes a handle portion operationally connected to the outer tube.

15. The apparatus of claim 14, including an inner tube slidably movable within the outer tube, the inner tube positioned within and coaxial with the outer tube along a longitudinal axis, the handle portion including at least two spur gears, the outer tube including a plurality of grooves, the inner tube including a first gear drive and a second gear drive, wherein the spur gears pivot between the grooves of the outer tube and the gear drives of the inner tube whereby the handle portion operationally connects the inner tube and the outer tube.

16. An animal litter apparatus for gathering pet waste, comprising:
an outer tube including an open end;
an inner tube slidably movable within the outer tube, and positioned within and coaxial with the outer tube along a longitudinal axis;
means for holding a closed end of a disposable bag within the outer tube;
means for moving the apparatus between open and closed configurations; and
a clamp assembly for grasping the waste as the apparatus moves from the open configuration to the closed configuration, connected generally about a perimeter of the outer tube open end, the outer tube operationally connected to the clamp assembly whereby slidable movement of the outer tube along a longitudinal axis away from and towards the clamp assembly respectively opens and closes the clamp assembly;
wherein the clamp assembly brings the waste into the bag as the apparatus moves from the open configuration to the closed configuration, the outer tube is rotatable about a longitudinal axis, and the clamp assembly is connected to the outer tube to rotate with the outer tube, twisting an open end of the bag closed.

17. The apparatus of claim 16, wherein the holding means is connected to the inner tube.

18. The apparatus of claim 16, including a spring connecting the inner tube to the moving means.

19. The apparatus of claim 16, wherein the inner tube moves away from the open end of the outer tube, pulling the bag further within the outer tube as the apparatus moves from the open configuration to the closed configuration.

20. The apparatus of claim 16, including a gear assembly operationally connecting the inner tube and the outer tube.

21. The apparatus of claim 16, wherein the clamp assembly includes at least two jaws, pivotally movable towards the open end of the outer tube as the apparatus moves from the open configuration to the closed configuration, and the outer tube surrounding a portion of the jaws as the apparatus moves from the open configuration to the closed configuration.

22. The apparatus of claim 16, wherein the holding means includes a clamp having two grips for holding the bag therebetween.

23. The apparatus of claim 16, wherein the moving means includes a trigger assembly operationally connected to the inner tube and holding means, a handle portion operationally connected to the outer tube, and the handle portion including at least two spur gears, the outer tube including a plurality of grooves, the inner tube including a first gear drive and a second gear drive, wherein the spur gears pivot between the grooves of the outer tube and the gear drives of the inner tube whereby the handle portion operationally connects the inner tube and the outer tube.

24. An animal litter apparatus for gathering pet waste, comprising:
an outer tube including an open end and rotatable about a longitudinal axis;
an inner tube slidably movable within the outer tube, and positioned within and coaxial with the outer tube along the longitudinal axis;
means for holding a closed end of a disposable bag within the outer tube including a clamp;
means for moving the apparatus between open and closed configurations including a trigger assembly operationally connected to the holding means; and
a clamp assembly for grasping the waste as the apparatus moves from the open configuration to the closed configuration, connected generally about a perimeter of the outer tube open end and connected to the outer tube to rotate with the outer tube, twisting an open end of the bag closed.
wherein the clamp assembly brings the waste into the bag as the apparatus moves from the open configuration to the closed configuration, and the outer tube is operationally connected to the clamp assembly whereby slidable movement of the outer tube along the longitudinal axis away from and towards the clamp assembly respectively opens and closes the clamp assembly.

25. The apparatus of claim 24, including a spring connecting the inner tube to the moving means and a gear assembly operationally connecting the inner tube and the outer tube, wherein the holding means is connected to the inner tube, and the inner tube moves away from the open end of the outer tube, pulling the bag further within the outer tube as the apparatus moves from the open configuration to the closed configuration.

26. The apparatus of claim 24, wherein the clamp assembly includes at least two jaws, pivotally movable towards the open end of the outer tube as the apparatus moves from the open configuration to the closed configuration, and the outer tube surrounds a portion of the jaws as the apparatus moves from the open configuration to the closed configuration.

27. The apparatus of claim 24, wherein the clamp includes two grips for holding the bag therebetween.

28. The apparatus of claim 24, wherein the moving means includes a handle portion operationally connected to the outer tube and having at least two spur gears, the outer tube including a plurality of grooves, the inner tube including a first gear drive and a second gear drive, wherein the spur gears pivot between the grooves of the outer tube and the gear drives of the inner tube whereby the handle portion operationally connects the inner tube and the outer tube.
